(19) United States
(12) Patent Application Publication
(10) Pub. No.: US 2019/0045154 A1
(43) Pub. Date: Feb. 7, 2019

(54) Techniques for Data Exchanges Among Multi-Radio Devices

(71) Applicant: Republic Wireless, Inc., Raleigh, NC (US)

(72) Inventors: Sai Rathnam, Raleigh, NC (US); James Mulcahy, Raleigh, NC (US); Jared Kashimba, Micanopy, FL (US); Matthew Newton, Park Ridge, IL (US); Michael Volz, Chicago, IL (US)

(21) Appl. No.: 16/047,469

(22) Filed: Jul. 27, 2018

Related U.S. Application Data
(60) Provisional application No. 62/538,929, filed on Jul. 31, 2017.

(51) Int. Cl. H04N 5/775; H04L 29/08; H04L 12/24

(52) U.S. Cl. CPC H04N 5/775; H04L 41/0896; H04L 67/2842

(57) ABSTRACT

Disclosed is a multi-radio communication apparatus capable of remote communication exchanges with a cloud based communication server. The communication server, in turn, may be communicable with one or more content or other customer servers to allow data exchanges between the multi-radio communication apparatus and virtually any cloud based server. The multi-radio communication apparatus may comprise processors, data storage components, a plurality of RF transceivers and corresponding antennas, and logic, at least a portion of which is implemented in circuitry. The logic may implement a mesh module configured to communicate with other apparatuses directly using a dedicated one of the plurality of RF transceivers. The logic may further implement a caching module configured to store data to be exchanged with a communication server at a later date. The logic may further implement a bonding module configured to: (i) receive multiple identical IP data streams via the plurality of RF transceivers; and (ii) send multiple identical IP data streams via the plurality of RF transceivers to the same destination.

### CROSS-REFERENCE TO RELATED APPLICATIONS

This application is a non-provisional application claiming the benefit of and priority to U.S. Provisional Application 62/538,929 filed Jul. 31, 2017 and entitled “Techniques for Data Exchanges Among Multi-Radio Devices”.

### BACKGROUND

There are many instances and use cases in which data must be uploaded from or downloaded to an endpoint device (hereinafter “multi-radio unit” or “MRU”) in remote areas that are not easily serviceable through direct human interaction or other locations where it is not practical or efficient to use human interaction that often.

What is needed is an apparatus, system, and/or method that can extend wireline and wireless communications to such MRUs that may either be communicable with or embedded within an appropriate peripheral device (e.g., video monitor, video recorder, etc.). This would provide an ability to download to or upload from the units without requiring human interaction with the MRUs. Such an apparatus, system, and/or method would further allow a network server to tailor content delivery to or extraction from a large scale deployment of MRUs.

### SUMMARY

Disclosed is a portable multi-radio unit (MRU). The MRU generally comprises and houses multiple RF radio transceivers capable of sending and receiving Internet Protocol (IP) packet data traffic over multiple networks. Within each MRU there may be a software component that manages the various RF transceivers. The software may be configured to determine the best and/or least expensive communication link to use when exchanging data between an MRU and a network server. The software may then manage the RF transceiver selection and usage process according to configurable rules or priorities. Additionally, the software may also configure multiple MRUs into a peer to peer mesh network using a dedicated mesh radio within each MRU. There may be other features set out in greater detail in the detailed description of the embodiments below.

### BRIEF DESCRIPTION OF THE DRAWINGS

FIG. 1 illustrates an MRU and its various internal components according to a first embodiment.

FIG. 2 illustrates an MRU and its various external components according to an embodiment.

FIG. 3 illustrates an exemplary networked environment for a deployment of multiple MRUs according to an embodiment.

FIG. 4 illustrates an exemplary use case for a deployment of multiple MRUs according to an embodiment.

FIG. 5A illustrates an example of a logic flow diagram according to an embodiment of the invention.

FIG. 5B illustrates another example of a logic flow diagram according to an embodiment of the invention.

FIG. 6 illustrates yet another example of a logic flow diagram according to an embodiment of the invention.

FIG. 7 illustrates still another example of a logic flow diagram according to an embodiment of the invention.

FIG. 8 illustrates still another example of a logic flow diagram according to an embodiment of the invention.

FIG. 9 illustrates still another example of a logic flow diagram according to an embodiment of the invention.

### DETAILED DESCRIPTION OF THE EMBODIMENTS

The embodiments described herein disclose apparatuses, systems, methods, and computer program products for establishing and managing communications between or among multi-radio devices communicable over one or more Internet Protocol (IP) networks. The apparatuses, systems and methods of the invention may be embodied in and performed by multi-radio units (MRUs), network based communication server(s), and other related components (e.g., databases), and software instructions executed by some or all of such devices and components, as will be explained in detail below. The different types of networks contemplated herein include, for example, IP based cellular mobile networks, and IP data networks, such as the Internet or other IP-based networks, including wide area networks, local area networks, and combinations thereof that include wireless 802.11 and wireless IP cellular means of access over a wide range of frequency spectrums.

As used herein the term “multi-radio device” or “MRU” is meant to generally indicate an end user physical device intended for, among other things, exchanging voice communication with other similar communication devices over one or more inter-connected communication networks. A communication device may be equipped with multiple RF transceivers including an 802.11 WiFi transceiver, a cellular banded transceiver, and (optionally) a Bluetooth transceiver. Other similar RF transceivers configured to use various frequency ranges may also be implemented on the communication device as they are developed. Other examples may be understood to those of ordinary skill in the art.

As used herein, the term “communication server” is intended to mean an IP based computer that, among other capabilities, mediates and manages data exchanges among MRUs and other network servers over one or more inter-connected IP networks. The IP based communication server may be hosted within an IP network accessible to the Internet.

As used herein, the term “communication link” is intended to mean a physical and/or logical path that connects an MRU with the IP based communication server. A communication link may be a signaling link, a media link, or both.

References herein to an MRU capable of connecting to or communicating via a mobile radio access network (MRAN) refer to an MRU equipped with a cellular RF transceiver for wireless communication with basestations for purposes of accessing cellular IP data services. Similarly, references herein to an MRU capable of connecting to or communicating via an IP data network refer to an MRU equipped with an RF transceiver for wireless communication (e.g., 802.11 WiFi) with a router or other IP data network access point.

The techniques described herein describe an adaptive and comprehensive solution for exchanging data between network servers and a deployment of one or more multi-radio units (MRUs) in situations where direct human interaction may be costly and/or inefficient. To achieve the features set forth herein, an MRU is described that may be deployed with other MRUs to provide data exchanging capabilities between the units, a communication server, and other networked servers. One feature of the MRUs may be the number and variety of separate communication links that may be enabled to communicate with network based servers and the other MRUs.

The least expensive and most reliable method of exchanging data between the network server and the unit is typically a direct wireline connection (e.g., Ethernet). However, such a wireline connection is often unavailable or impractical. The next cheapest method may be to run wireline to a network access point that can communicate with one or more MRUs using a form of 802.11 WiFi. Many times, however, the MRUs may be situated where not all of them have a good or reliable WiFi connection to the network access point. Typically, the most expensive method is to rely on a cellular IP connection to connect each unit to an IP backhaul network and ultimately to a network based server. While expensive, such deployments may sometimes be the only available means of connecting a MRU with a network server.

The MRUs described herein each contain one or more RF transceivers, ports, and/or interfaces for accessing and using Ethernet networks, WiFi networks, and cellular networks. Moreover, an MRU may include multiple cellular radios but even if there is only one cellular radio there may be multiple subscriber identity module (SIM) card identifiers that can cause the radio to establish communications with different cellular networks. If an MRU is located where one cellular network has poor or no connectivity, the MRU can switch over to a second, third, or even fourth cellular network to find the best connection.

There are several features that render a deployment of MRUs ideal for remote, economical, and relatively large-scale data transfers with network servers. Some of these features (in no particular order) include intelligent network selection, intelligent data caching, multi-path IP bonding, network failover handling, configurable mesh networking among MRUs, and multi-path IP bonding over mesh.

Intelligent Network Selection

Intelligent network selection refers to methods and processes for determining which radios and networks to use for a given data exchange between an MRU and a network server. Each unit includes multiple radios operable over multiple networks. The cost to utilize each network may be different. Moreover, the use case for a given data exchange may vary as well taking into consideration, among other factors, the amount of data to be exchanged, whether the data is intended to be consumed in real-time, and the priority of ensuring the data exchange completes. For instance, a real-time exchange of a relatively small amount of data for a high priority task may rank reliability over cost when selecting which radio and network to use. On the other hand, a non real-time (i.e., delayed) exchange of a relatively large amount of data for a less critical task may rank cost over reliability when selecting which radio and network to use. Intelligence may be embedded into the MRUs to automatically perform network selection based on the criteria described above. The selection may be communicated back to the network and/or a communications server.

Intelligent Data Caching

Intelligent data caching refers to delivering data over cellular networks during off-peak hours when both the cost of exchanging data and network traffic may be lower. In many scenarios and use cases, data need not be exchanged on a real-time basis meaning it need not be consumed by the receiver immediately. In addition, there may be no WiFi or Ethernet connectivity. In such cases, the data may be exchanged using cellular networks at times when doing so costs less on a per megabyte basis. These times, typically in the early morning hours, also align with lower network utilization. In situations when Ethernet or WiFi is not available to the MRUs and the data is not needed in real-time, intelligent data caching may be utilized to minimize costs. For instance, the data may be downloaded to the MRU at 3:00 AM but the MRU may not use the data until 10:00 AM.

Multi-Path IP Bonding

Multi-path IP bonding refers to the ability of an MRU to concurrently utilize more than one radio and network (e.g., communication path) to communicate with a network server via a communication server. For instance, an MRU may have a cellular data connection and a WiFi data connection available. Invoking multi-path bonding permits the MRU to send and receive the same IP packet data stream simultaneously, each stream utilizing a different radio/network. Bonding may be used when the use case scenario is highly quality dependent. If one of the communication links experiences quality issues such as dropped packets, the identical packets from the other communication link may be inserted into the packet data stream to ensure a high quality data exchange. For bonding to work, both the MRU and communication server must be capable of sending multiple concurrent identical packet data streams and combining multiple received packet data streams into a single high quality usable packet data stream.

Network Failover Handling

Network failover handling refers to dynamically switching between or among radios and networks to ensure a data exchange is not terminated prematurely or significantly degraded. Failover is related to bonding in that multiple radios and networks may be invoked. However, rather than running the radios concurrently, intelligence within the MRU and/or a network side communication server may monitor the quality (e.g., latency, dropped packets) of a communication path and switch to a new communication link using a different radio/network combination when the quality of the current communication link degrades. Moreover, the intelligence may continuously monitor the quality of the communication links to predictively determine whether and when a failover is imminent and a network handoff is needed. This may provide extra time to spin up the new communication link so there is less chance of a complete loss of a portion of the packet data stream being transmitted or received. There may also be signaling communication between an MRU and the communication server to ensure they stay in sync as to which communication link to use.

Configurable Mesh Networking Among Units

Configurable mesh networking among units refers to an ability for multiple MRU to communicate with one another on a peer-to-peer basis over a mesh network topology. When multiple MRU are deployed close enough to one another, they may establish their own peer-to-peer communication network using, for instance, a dedicated 802.11 WiFi radio within each MRU. Such a radio may be used exclusively for mesh communications with other MRUs. In such deployments, only one MRU need be able to communicate with a network server (via a communication server). That particular MRU may then act as the distribution point (upload and download) for other MRUs so they may also exchange data with the network server. For upload, any MRU may funnel data to be uploaded to the “connected” MRU either directly or through other MRUs in the mesh topology so the data may find its way to the network server. Similarly for download, any MRU may be the “connected” MRU and funnel data to other MRUs either directly or through other MRUs in the mesh topology so the data may find its way to the end MRU. Such a configuration may save significant money because only one MRU within a deployment of many need utilize an expensive cellular data connection at a time rather than all of them. If that MRU loses its cellular connection, one of the other MRUs may take its place to keep the overall system intact.

Multi-Path IP Bonding Over Mesh

Multi-path bonding over mesh combines the mesh feature and the bonding feature to create even higher quality packet data streams. Each MRU may only contain a single cellular radio but may be connectable to multiple cellular networks via, for instance, multiple SIM cards. Thus, one MRU may establish a communication path using a first cellular network while a second MRU may establish a communication path using a second cellular network. Both MRUs may be tasked with sending and receiving the same packet data stream which may be re-transmitted over the mesh network to the other MRUs. Each MRU may then combine, using the bonding process, all the received packet data streams to create a single high quality packet data stream to be used according to the current use case scenario.

Even in upload use case scenarios where an MRU that is gathering data to be uploaded to a network server cannot connect to any backhaul network (e.g., WiFi or cellular) at all, it may be able to use the mesh network to find another MRU capable of acting as the backhaul connection point—be it WiFi, cellular, or even Ethernet. Thus, an MRU with no wide area connectivity may still be viable using a mesh network configuration with other MRUs.

The aforementioned features are more fully described with reference to the figures.

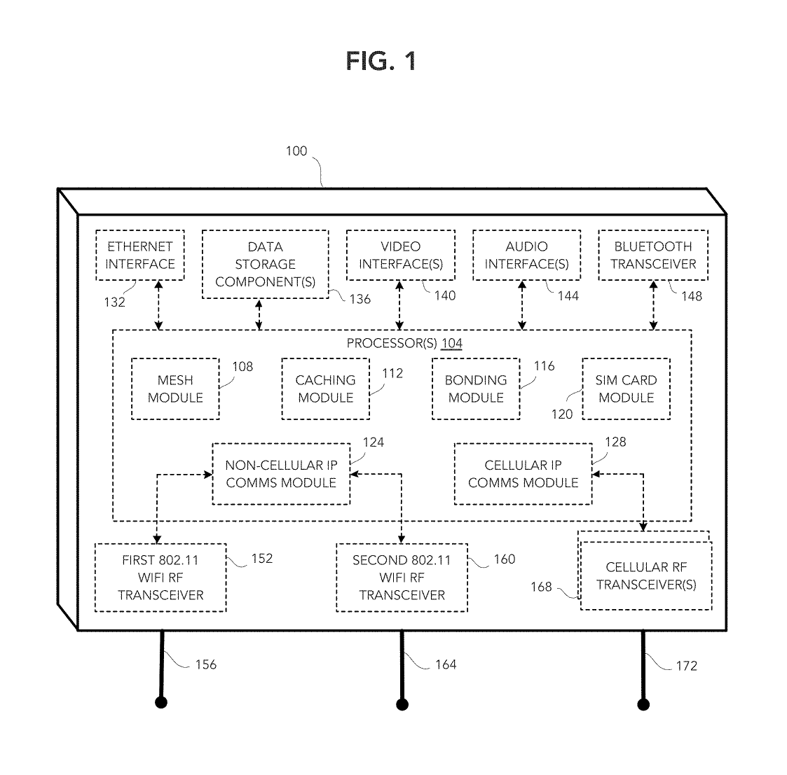

FIG. 1 illustrates a multi-radio unit (MRU) 100 and its various internal components according to a first embodiment. It should be noted that not every internal component is necessary for an MRU to be functional. For example, some MRUs may have more or less radios depending on the anticipated environment for a deployment.

The MRU 100 may be controlled by one or more processors 104. The processors 104 may control multiple functional modules including a mesh module 108, a caching module 112, a bonding module 116, and a SIM card module 120. Each of these modules may include software or instructions stored in one or more data storage components 136 that may be executed by the processors 104. Additionally, the MRU 100 may also include multiple input/output interfaces including at least one of each of an Ethernet interface 132, video interface 140, and audio interface 144. Moreover, the MRU 100 may also include multiple RF transceivers including at least one of each of a Bluetooth transceiver 148, 802.11 WiFi transceiver(s) 152, 160, and cellular transceiver 168. Each RF transceiver may be operatively coupled with a respective antenna 156, 164, 172.

At least one 802.11 WiFi transceiver 160 may be reserved for and dedicated to a peer-to-peer mesh communication network with other MRUs 100. There may also be multiple communication modules controlling the RF transceivers. There may be a non-cellular IP communication module 124 and a cellular IP communication module 128. The design of the MRU 100 shown is exemplary and mainly illustrative to one of ordinary skill in the art. Other and/or additional RF transceivers may be incorporated into an MRU 100 as appropriate. One such additional RF transceiver may be, for instance, a satellite transceiver to provide even more remote unit connectivity. The actual physical arrangement of the components within the MRU 100 is left to design choice to allow the radios and antennas to perform their functions without interfering with one another.

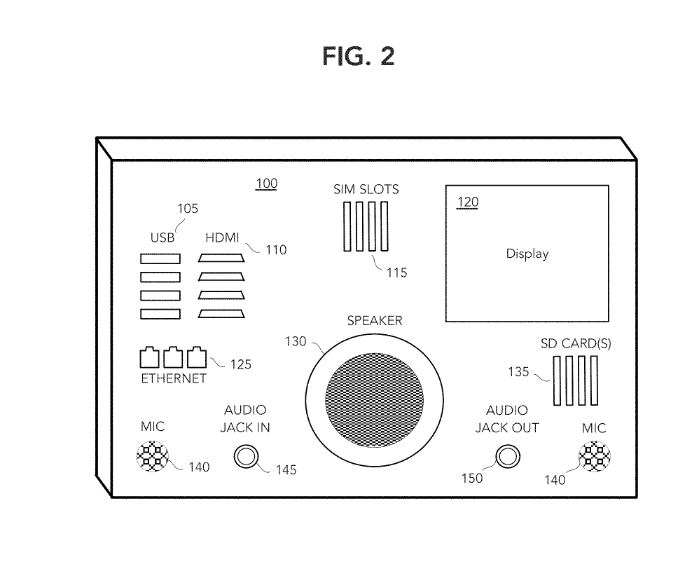

FIG. 2 illustrates an MRU 100 and its various external components according to an embodiment. It should be noted that not every external component is necessary for an MRU 100 to be functional. For example, some MRUs 100 may have more or less ports depending on the anticipated environment for a deployment.

A MRU 100 may include one or more cable connectivity ports such as universal serial bus (USB) ports 105 and Ethernet ports 125, video ports such as high definition multi-media interface (HDMI) ports 110, external memory ports such as secure digital (SD) card ports 135, audio ports such as microphones 140, speaker 130 and audio input 145 and audio output 150 jacks. An MRU 100 may further include cellular connectivity ports such as SIM slots 115 to enable communication with one or more cellular networks. An optional display 120 may be included directly on the MRU 100. Each of the ports may be operably coupled with one or more of the internal components to perform a function or provide a means of importing or exporting data between the MRU 100 and an appropriate peripheral device. Other ports not shown but easily incorporated into the unit design include a power source port or a battery chamber and battery charging port.

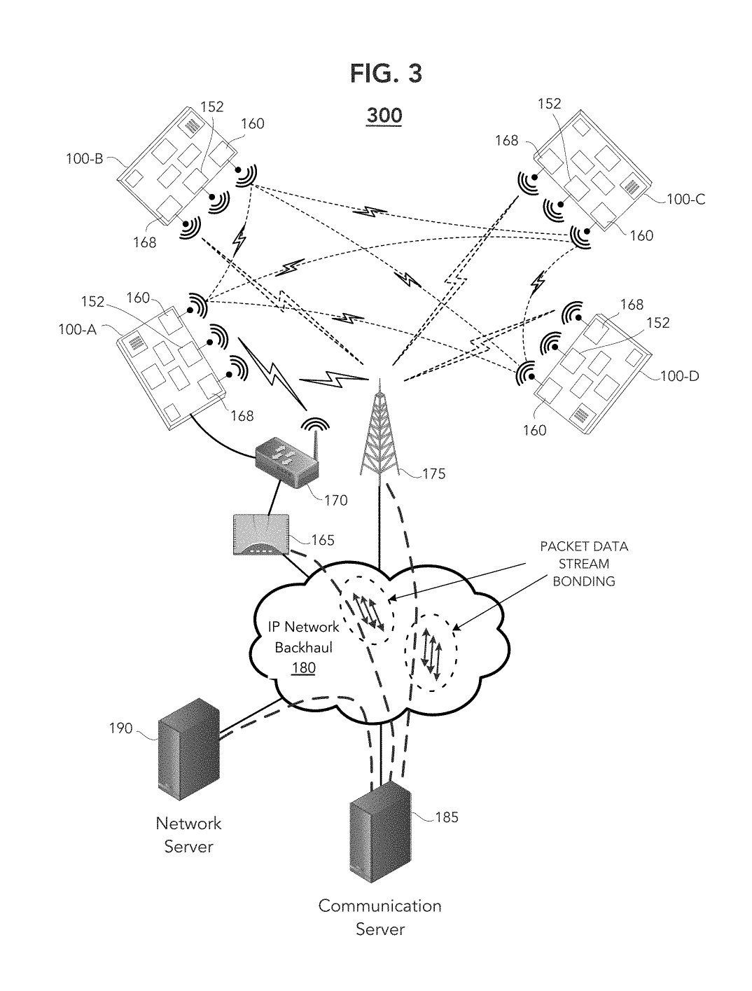

FIG. 3 illustrates an exemplary networked environment 300 for a deployment of multiple MRUs 100 according to an embodiment. In this example embodiment four MRUs 100-A, 100-B, 100-C, 100-D are illustrated and arranged to demonstrate their inter-connectivity with one another and with a larger packet based network 180. This embodiment illustrates an environment capable of downloading data from a network server 190 through a communication server 185 to a deployment of MRUs 100-A, 100-B, 100-C, 100-D using one or more communication networks and communication links. For download, the network server 190 may initially forward the data it wishes to distribute to the MRUs 100-A, 100-B, 100-C, 100-D to the communication server 185. The communication 185 may be responsible for organizing and maintaining one or more communication links with the deployment of MRUs 100-A, 100-B, 100-C, 100-D. The communication links may occur over one or more networks using one or more communication protocols.

In a typical implementation, the communication server 185 will establish a communication link with at least one of the deployed MRUs such as MRU 100-A and begin downloading data to that MRU 100-A. One of the communication links illustrated may be a direct wireline connection through the IP backhaul network 180 to a modem 165 coupled with a network access point 170 (e.g., router). Often, the modem 165 and network access point 170 may be combined into a single device. Another of the communication links illustrated may be a direct wireline connection through the IP backhaul network 180 to a cellular basestation and radio tower 175. The cellular basestation and radio tower 175 may then transmit the data to at least one of the deployed MRUs 100-A based on an intended recipient ID (e.g., telephone number, radio ID, or IP address) of MRU 100-A.

The preferable communication link from communication server 185 to MRU 100-A is wireline to modem 165. From modem 165, data may be forwarded to MRU 100-A via a direct Ethernet cable (if available) or over an 802.11 WiFi connection via network access point 170. Network access point 170 may then distribute the data to one or more of the MRUs 100-A, 100-B, 100-C, 100-D via the first RF WiFi transceiver 152 within each MRU 100. A fallback communication link option may be a cellular connection between communication server 185 and MRU 100-A using the cellular RF transceiver 168 within MRU 100-A.

If the MRUs 100-A, 100-B, 100-C, 100-D are configured for a mesh topology, MRU 100-A may act as the link to the backhaul network 180 in communication with the communication server 185. MRU 100-A may distribute the data it receives from network access point 170 to the other MRUs 100-B, 100-C, 100-D. Any MRUs 100-A, 100-B, 100-C, 100-D not within range of network access point 170 may receive the data over the second RF WiFi transceiver 160 that is dedicated to the mesh topology. Alternatively, MRU 100-A may distribute the data it receives from cellular basestation 175 to cellular RF transceiver 168 to the other MRUs 100-A, 100-B, 100-C, 100-D over the second RF WiFi transceiver 160 that is dedicated to the mesh topology. The mesh topology allows the second RF WiFi transceiver 160 to communicate with any of the other MRUs 100 using the dedicated second RF WiFi transceiver 160 in each MRU 100.

This embodiment also illustrates an environment capable of uploading data to a network server 190 through a communication server 185 from a deployment of MRUs 100-A, 100-B, 100-C, 100-D using one or more communication networks and communication links. The process is essentially the reverse of the download. Specifically, a MRU 100 (e.g., 100-C) may be tasked with uploading data to the network server 190 via the communication server 185. The MRU 100-C first determines whether it can connect to the backhaul network 180 and communicate with communication server 185. The connection may be through network access point 170 and modem 165 or may be through a cellular basestation 175. If there is no WiFi connectivity to network access point 170, further steps may be taken to determine if one of the other MRUs 100-A, 100-B, 100-D can connect to network access point 170. If so, MRU 100-C may forward the data to be uploaded to the MRU 100 (e.g., 100-D) that has a connection to network access point 170. From a cost point of view, this may be preferable to using the cellular transceiver 168 to transfer the data to the backhaul network 180. Once the data gets to the communication server 185 it may be forwarded on to the network server 190 for consumption according to the use case.

For higher priority and higher quality use cases, the MRUs 100-A, 100-B, 100-C, 100-D and the communication server 185 may employ packet data stream bonding to ensure the integrity of the data transferred is the highest quality possible. Bonding entails utilizing multiple communication paths and communication links concurrently to send the same packet data stream. Gaps (e.g., packet loss) in any of the communication links may be filled in with the identical packets from one of the other packet data streams using a different communication link. There can be multiple 802.11 WiFi and cellular packet data streams exchanged between a deployment of MRUs 100-A, 100-B, 100-C, 100-D and communication server 185.

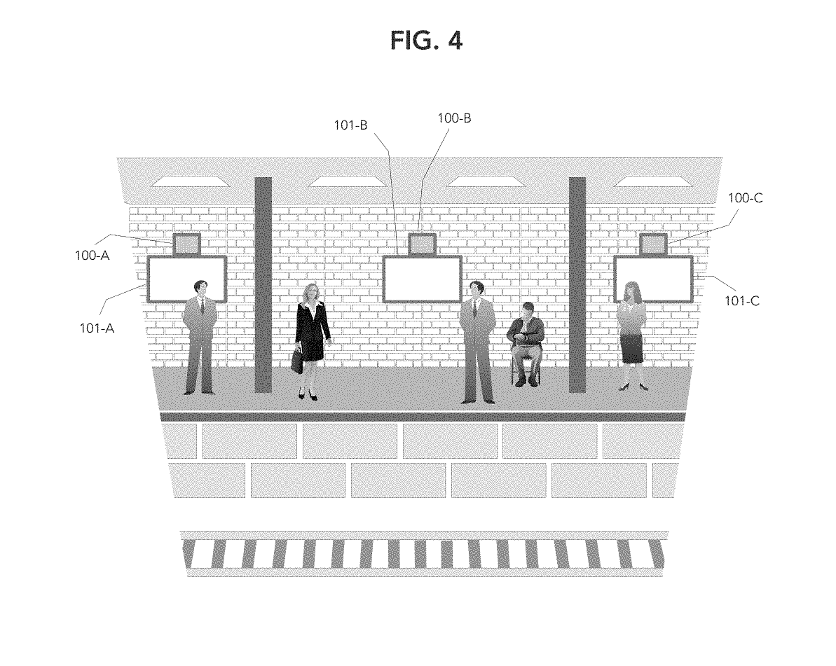

FIG. 4 illustrates an exemplary use case for a deployment of multiple MRUs 100-A, 100-B, 100-C according to an embodiment. In this example, a train station platform 400 is depicted with several commuters awaiting a train. On the wall are multiple displays 101-A, 101-B, 101-C each coupled to a data exchange MRU 100-A, 100-B, 100-C respectively. The MRUs 100-A, 100-B, 100-C may be equipped as described above with multiple RF transceivers including one for dedicated mesh networking communications among the MRUs 100-A, 100-B, 100-C. Thus, each MRU 100-A, 100-B, 100-C may exchange data with any other MRU 100-A, 100-B, 100-C using a mesh topology and the dedicated mesh radio within each MRU 100-A, 100-B, 100-C.

In addition, at least one of the MRUs 100-A, 100-B, 100-C may be communicable with an IP backhaul network 180 that can reach the communication server 185. The communication server 185 may be further communicable with a customer server 190. The connection between a MRU 100-A, 100-B, 100-C may be a local area network (LAN) based connection such as an Ethernet connection to a modem with Internet access or an 802.11 WiFi connection to a wireless network access point coupled with a modem with Internet access. Alternatively, the connection between a MRU 100-A, 100-B, 100-C may be a wide area network (WAN) cellular based connection. So long as at least one MRU 100-A, 100-B, 100-C has an IP backhaul connection, the deployment of MRUs 100-A, 100-B, 100-C may exchange data with the network server 190 using the techniques described above.

The illustration in FIG. 4 may be used, for instance, in an advertising scenario, electronic billboards or displays 101-A, 101-B, 101-C may be used to display certain advertisements. The advertisements may be static (pictorial) images or dynamic (video) snippets. Either way, the content is digital and may be downloaded from a centralized location such as a network server 190 to a deployment of MRUs 100-A, 100-B, 100-C in the form of IP data packets that are representative of video or image content files. These files, once downloaded to the MRUs 100-A, 100-B, 100-C may be output via one or more I/O ports to an appropriate peripheral device 101-A, 101-B, 101-C (e.g, electronic billboard, television screen, or the like) for display.

If the MRUs 100-A, 100-B, 100-C are situated in a remote area it may not have dedicated wireline (e.g., Ethernet) connectivity to a larger network such as the Internet. Without such connectivity, downloading the content files for output on the appropriate peripheral device such as a video display 101-A, 101-B, 101-C may not be possible without human interaction. Human interaction may take the form of physically connecting a storage device containing the content files to the appropriate peripheral device such as inserting a USB jump drive into an electronic billboard. If an enterprise owns or maintains large numbers of appropriate peripheral devices it becomes impractical very quickly to rely on human interaction with each appropriate peripheral device.

Moreover, there may be deployments of s that are clustered in a relatively close geographic density. In such cases, the MRUs 100-A, 100-B, 100-C may be configured to create and operate a mesh communication network using, for instance, a closed local 802.11 WiFi system. In such deployments, if a single MRU 100-A, 100-B, 100-C were to have a wired Ethernet connection, that MRU 100-A, 100-B, 100-C could be the original destination of one or more content files that may, in turn, be distributed to one or more selected other MRUs 100-A, 100-B, 100-C using the mesh network.

Even if there is no wireline connectivity available whatsoever for a specific deployment of MRUs 100-A, 100-B, 100-C, one or more of the MRUs 100-A, 100-B, 100-C may be equipped with a cellular RF transceiver 168 capable of wireless communication over greater distances. The cellular RF transceiver 168 may be utilized to send and receive content files for distribution among the other MRUs 100-A, 100-B, 100-C.

Because cellular based communication is typically the most expensive form of communicating (e.g., IP packet data exchanges), its use may be monitored and controlled in a least cost routing (LCR) type fashion (e.g., time of day). Additionally, the cellular transceiver 168 may be used sparingly to support other more economical modes of communication. That may mean using the cellular transceiver 168 as a parallel and concurrent communication link for sending and receiving content files. For example, the cellular transceiver 168 may only be utilized when the quality of one of the other wireless transceivers (e.g., WiFi) dips to insufficient levels. Such quality dips are often temporary so the cellular backup may only be necessary during these temporary periods to maintain an overall quality of service.

Another typical deployment of MRUs 100-A, 100-B, 100-C in an urban setting may be as traffic cameras. Many of these cameras do not live stream video 24/7 due to connectivity shortcomings and/or cost. Hard-wiring these devices (especially in a retrofit scenario) often proves difficult to impossible. Adding one or more wireless options to these devices greatly enhances their ability to send live video back to a centralized location.

As stated earlier, there are several features that render a deployment of MRUs 100 ideal for remote, economical, and relatively large-scale data transfers with network servers that include intelligent network selection, intelligent data caching, multi-path IP bonding, network failover handling, configurable mesh networking among MRUs, and multi-path IP bonding over mesh.

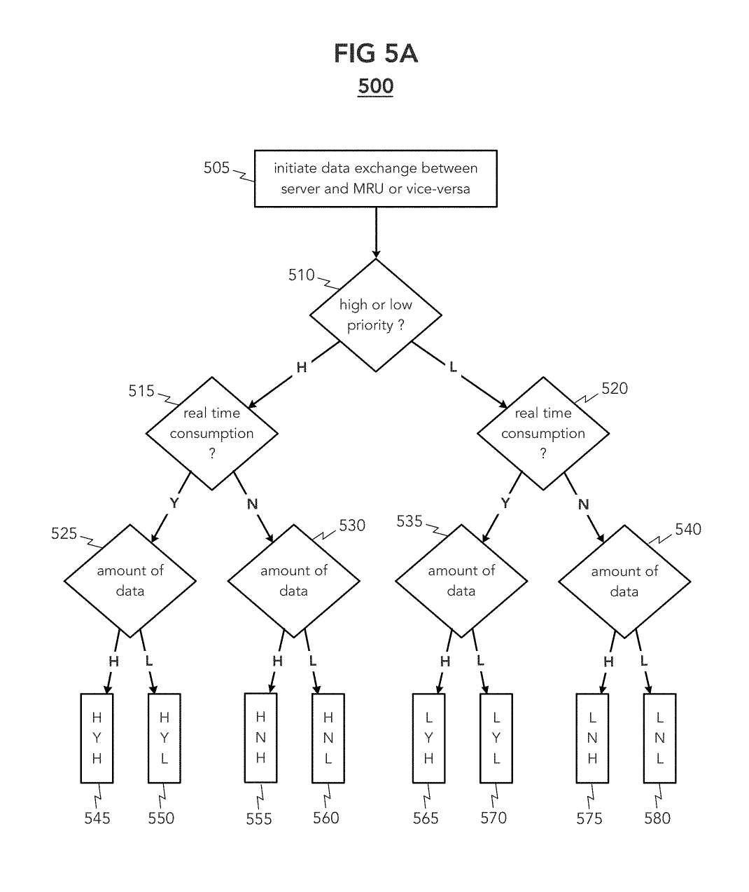

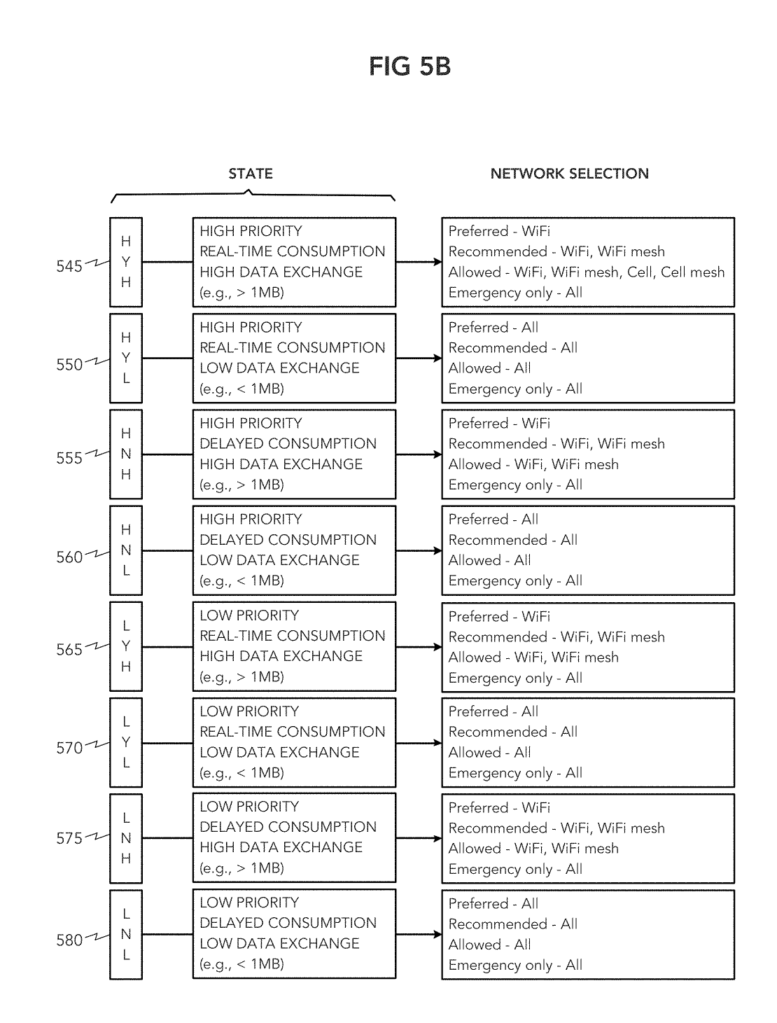

FIGS. 5-9 illustrate examples of logic flow diagrams according to embodiments of the invention relating to intelligent network selection, intelligent data caching, multi-path IP bonding, network failover handling, configurable mesh networking among MRUs, and multi-path IP bonding over mesh. The logic flows may be representative of some or all of the operations executed by one or more embodiments described herein. Further, the logic flows may performed by circuitry and one or more components discussed herein. Moreover, logic flows may be performed in conjunction with one or more other logic flows discussed herein and lists particular steps occurring in a particular order. However, embodiments are not limited in this manner and any step may occur in any order. Further, steps of the logic flows may not be dependent upon one another and as such particular steps in the logic flows may not occur.

Intelligent Network Selection

FIG. 5A illustrates an example of a logic flow diagram 500 according to an embodiment of the invention. FIG. 5A is more akin to a three variable state diagram. When a data exchange between a network server 190 and an MRU 100 is initiated, the data exchange may be characterized using three relevant factors that define the data exchange. The three factors may be binary in nature and may include (i) the priority or importance of the data exchange, (ii) whether the receiving party will be consuming the data exchanged instantly in real-time or at a later (perhaps scheduled) time, and (iii) how much data will be exchanged. A binary three-factor state diagram will yield eight (8) possible states. It should be noted, the data exchange applies equally to uploads and downloads meaning whether an MRU 100 is sending information to or receiving information from a network server 190. It should also be noted that one or more of the factors may be more than just binary in nature which could lead to more potential states. For instance, the amount of data exchanged factor may be separated into more than just two buckets of low and high. Moreover, the threshold level separating a low amount of data to be exchanged and a high amount of data to be exchanged may be a configurable design choice. For purposes of illustration, the specification arbitrarily selected 1 MB as the cutoff between low and high data exchanges. The states for the amount of data exchanged could be characterized as low, middle, high. In this scenario, low may be considered 0-500 kilobytes (KB), middle may be considered 0.5 MB-5 MB, and high may be considered greater than 5 MB. Similarly, the priority factor may be set as low, neutral, and high as opposed to just low and high. The binary states described herein are merely illustrative and should not be deemed limiting of the specification or claims. Using three states for both the amount of data and the priority of a data exchange elevates the total number of states from eight (8) to eighteen (18) in the model above. For ease of illustration, FIGS. 5A and 5B have been arbitrarily limited to an eight (8) state model though one of ordinary skill in the art could readily expand the states as described above without departing from the spirit or scope of the disclosure.

Upon initiation of a data exchange in step 505, a first factor (e.g., priority) may be determined in decision block 510. If the priority of the data exchange is determined to be high in decision block 510 control moves to decision block 515 to determine the second factor—whether the data exchanged will be consumed in real-time or non real-time (i.e., delayed). If the nature of the data exchange is determined to be real-time in decision block 515 control moves to decision block 525 to determine the third factor—whether the amount of data exchanged is considered high. If the amount of data exchanged is determined to be high in decision block 525, the final state 545 of the data exchange may be characterized as high priority, real-time consumption, high amount of data exchanged. If the amount of data exchanged is determined to be low in decision block 525, the final state 550 of the data exchange may be characterized as high priority, real-time consumption, low amount of data exchanged.

If the priority of the data exchange is determined to be high in decision block 510 control moves to decision block 515 to determine the second factor—whether the data exchanged will be consumed in real-time or later. If the nature of the data exchange is determined not to be real-time (e.g., later consumption) in decision block 515 control moves to decision block 530 to determine the third factor—whether the amount of data exchanged is considered high. If the amount of data exchanged is determined to be high in decision block 530, the final state 555 of the data exchange may be characterized as high priority, non real-time consumption, high amount of data exchanged. If the amount of data exchanged is determined to be low in decision block 530, the final state 560 of the data exchange may be characterized as high priority, non real-time consumption, low amount of data exchanged.

If the priority of the data exchange is determined to be low in decision block 510 control moves to decision block 520 to determine the second factor—whether the data exchanged will be consumed in real-time or later. If the nature of the data exchange is determined to be real-time in decision block 520 control moves to decision block 535 to determine the third factor—whether the amount of data exchanged is considered high. If the amount of data exchanged is determined to be high in decision block 535, the final state 565 of the data exchange may be characterized as low priority, real-time consumption, high amount of data exchanged. If the amount of data exchanged is determined to be low in decision block 535, the final state 570 of the data exchange may be characterized as low priority, real-time consumption, low amount of data exchanged.

If the priority of the data exchange is determined to be low in decision block 510 control moves to decision block 520 to determine the second factor—whether the data exchanged will be consumed in real-time or later. If the nature of the data exchange is determined to be non real-time (e.g., later consumption) in decision block 520 control moves to decision block 540 to determine the third factor—whether the amount of data exchanged is considered high. If the amount of data exchanged is determined to be high in decision block 540, the final state of 575 the data exchange may be characterized as low priority, non real-time consumption, high amount of data exchanged. If the amount of data exchanged is determined to be low in decision block 540, the final state 580 of the data exchange may be characterized as low priority, non real-time consumption, low amount of data exchanged.

These eight (8) states may now be used to determine which network to use for the data exchange given a choice of networks.

FIG. 5B illustrates another example of a logic flow diagram according to an embodiment of the invention. Each of the eight (8) states is examined and a network preference is determined based on the state or characterization of the data exchange. There are four (4) separate network configurations that may be used to effect the data exchange. The four (4) network configurations may include: (i) a direct 802.11 WiFi connection from the MRU to a network access point; (ii) an indirect mesh connection from an MRU to one or more other MRUs where the last MRU in the mesh network has a direct WiFi connection to a network access point; (iii) a direct cellular connection from the MRU to a mobile basestation; and (iv) an indirect mesh connection from an MRU to one or more other MRUs where the last MRU in the mesh network has a direct cellular connection from the MRU to a mobile basestation. The selection of one of these network configurations may be prioritized based on the state characteristics of the data exchange. For instance, there may be four (4) levels of network priority including a preferred network, recommended network(s), allowed network(s), and emergency only network(s). The network characterizations may be based on a balancing of the cost, quality, accuracy, and timeliness needed for the data exchange. The preferred network may be the one that is best suited based on cost, quality, accuracy, and timeliness for the state of the data exchange. The recommended network(s) may be a ranking of the one(s) that can satisfy based on cost, quality, accuracy, and timeliness for the state of the data exchange. The allowed network(s) may be a ranking of the one(s) that can be justified based on cost, quality, accuracy, and timeliness for the state of the data exchange. Lastly, the emergency only network(s) may be a ranking of the one(s) that can be used if necessary based on cost, quality, accuracy, and timeliness for the state of the data exchange. The preferred network may be the one that satisfies more criteria (cost, quality, accuracy, timeliness, etc.) and to a greater degree than any other network. A recommended network may not satisfy the criteria as well as a preferred network but still meets or exceeds many criteria. An allowed network may be one that is not as good as a recommended network but still fits within the parameters of acceptance. For instance, an allowed network may be less cost effective but not so much as to warrant refusal. Lastly, an emergency only network may be one in which the economics of using the network are not entirely justifiable but other factors such as customer satisfaction may outweigh the economics for a given data exchange enough to warrant use of the network.

The first state 545 is indicative of a data exchange that is high priority, will be consumed in real-time, and involves a high amount of data to be exchanged. Based on these characteristics of the data to be exchanged, network selection may be prioritized as follows. WiFi may be the preferred network primarily due to the high amount of data to be exchanged and the cost differences between WiFi usage (free) versus cellular usage (per MB charge). WiFi is also good for real-time consumption and may be trusted for high priority data exchanges. WiFi and WiFi mesh may be recommended again primarily based on the high amount of data to be exchanged. WiFi mesh may be slightly less preferred based on a slightly more complex data path that may introduce accuracy and or timeliness issues as compared to a direct WiFi connection. Just below recommended network status is allowed network status. For this first state 545, WiFi, WiFi mesh, cellular, and cellular mesh may be deemed allowed primarily based on the high priority, real-time consumption nature of the data exchange. One could envision a scenario in which the amount of data to be exchanged was high enough to outweigh the priority of the data exchange leading to refusal of cellular networks. However, if the priority of the data exchange is so high as to outweigh the amount of data consideration, the emergency only network criteria may kick in to allow any available network, including cellular and cellular mesh, to effect the data exchange.

The second state 550 is indicative of a data exchange that is high priority, will be consumed in real-time, and involves a low amount of data to be exchanged. Based on these characteristics of the data to be exchanged, network selection may be prioritized as follows. Because of the low data amount to be exchanged, all networks may be considered preferred. Because the network priority eases as you go from preferred to recommended to allowed to emergency only, all networks will be permitted under the categories of recommended, allowed, and emergency only. In other words, if all networks are permitted for the most stringent of conditions, it naturally follows that all networks will be permitted for less stringent conditions.

The third state 555 is indicative of a data exchange that is high priority, may not be consumed in real-time, and involves a high amount of data to be exchanged. Based on these characteristics of the data to be exchanged, network selection may be prioritized as follows. WiFi may be the preferred network primarily due to the high amount of data to be exchanged and the cost differences between WiFi usage versus cellular usage. WiFi is also good for real-time consumption and may be trusted for high priority data exchanges. WiFi and WiFi mesh may be recommended again primarily based on the high amount of data to be exchanged. WiFi mesh may be slightly less preferred based on a slightly more complex data path that may introduce accuracy and or timeliness issues as compared to a direct WiFi connection. The allowed network(s) for this third state 555 may exclude cellular and cellular mesh primarily based on the delayed consumption nature of the data exchange. Because the data exchange may not be consumed for a period of time, there is no need to effect the data exchange immediately. Therefore, the system can wait to make the exchange until a preferred or recommended network is available. However, the length of time the data exchange can be deferred may not be indefinite. Once the delay gets below a certain threshold, the emergency only network may kick in to allow cellular and cellular mesh connectivity to effect the data exchange.

The fourth state 560 is indicative of a data exchange that is high priority, may not be consumed in real-time, and involves a low amount of data to be exchanged. Based on these characteristics of the data to be exchanged, network selection may be prioritized as follows. Because of the low data amount to be exchanged, all networks may be considered preferred. Because the network priority eases as you go from preferred to recommended to allowed to emergency only, all networks will be permitted under the categories of recommended, allowed, and emergency only. In other words, if all networks are permitted for the most stringent of conditions, it naturally follows that all networks will be permitted for less stringent conditions.

The fifth state 565 is indicative of a data exchange that is low priority, will be consumed in real-time, and involves a high amount of data to be exchanged. Based on these characteristics of the data to be exchanged, network selection may be prioritized as follows. The fifth state 565 is very similar to the third state 555 with the notable exception of the priority of the data exchange being lower in this fifth state 565. Thus the rationale applied to the third state 555 is even more compelling in the fifth state 565. The result yields a network selection that is the same as that described for the third state 555 above.

The sixth state 570 is indicative of a data exchange that is low priority, will be consumed in real-time, and involves a low amount of data to be exchanged. Based on these characteristics of the data to be exchanged, network selection may be prioritized as follows. Because of the low data amount to be exchanged, all networks may be considered preferred. Because the network priority eases as you go from preferred to recommended to allowed to emergency only, all networks will be permitted under the categories of recommended, allowed, and emergency only. In other words, if all networks are permitted for the most stringent of conditions, it naturally follows that all networks will be permitted for less stringent conditions.

The seventh state 575 is indicative of a data exchange that is low priority, may not be consumed in real-time, and involves a high amount of data to be exchanged. Based on these characteristics of the data to be exchanged, network selection may be prioritized as follows. The seventh state 575 is very similar to the fifth state 565 with the notable exception of the amount of data exchanged being low in this seventh state 575. Thus the rationale applied to the fifth state 565 is even more compelling in the seventh state 575. The result yields a network selection that is the same as that described for the third state 555 and fifth state 565 above.

The eighth state 580 is indicative of a data exchange that is low priority, may not be consumed in real-time, and involves a low amount of data to be exchanged. Based on these characteristics of the data to be exchanged, network selection may be prioritized as follows. Because of the low data amount to be exchanged, all networks may be considered preferred. Because the network priority eases as you go from preferred to recommended to allowed to emergency only, all networks will be permitted under the categories of recommended, allowed, and emergency only. In other words, if all networks are permitted for the most stringent of conditions, it naturally follows that all networks will be permitted for less stringent conditions.

Intelligent Data Caching

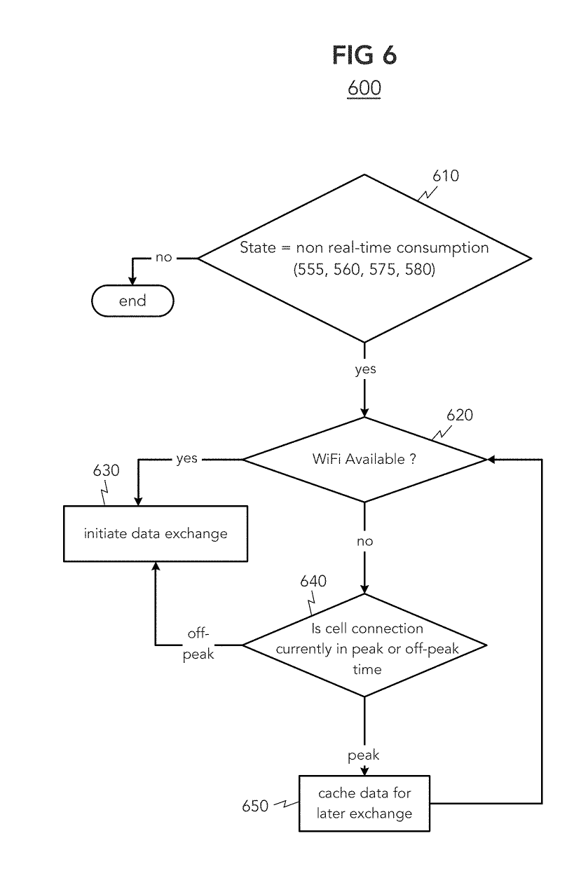

FIG. 6 illustrates yet another example of a logic flow diagram 600 according to an embodiment of the invention. In this embodiment, the data to be exchanged may be cached for a later exchange time based on cost, network congestion, or other factors. For caching to be available, the data exchange itself may be considered non real-time consumption as per the state diagrams of FIG. 5. A check may be made in decision block 610 to determine if the state of the data exchange is non real-time consumption. For instance, a new electronic billboard advertisement (in the form of a video file) may be downloaded to an electronic billboard coupled with an MRU 100. The new advertisement may not be scheduled to begin displaying until 2:00 PM the following day. Thus, downloading the video file the night before is not as critical so long as the video file gets downloaded prior to 2:00 PM the next day. The cellular network 175 may be the only viable network to get the video file from the customer server 190 to the MRU 100 (by way of communication server 185). Many times, the cellular network 175 may experience lower data volumes and even cheaper per MB pricing in off-peak hours. Off-peak may, but need not, be between midnight and 6:00 AM for example. During these hours, using the cellular network 175 may be cheaper and less congested.

If the result of decision block 610 is that the data exchange is not non real-time consumption, the delayed caching process is not available. However, if the result of decision block 610 is that the data exchange is non real-time consumption, the next determination may be to determine whether a WiFi network 165 is available in decision block 620. If a WiFi network 165 is available, the data exchange may commence immediately via block 630 as there is no (or an insignificant) additional cost for the data exchange. If a WiFi network 165 is not available, a further determination is made at decision block 640 as to whether the available cellular networks 175 are currently in peak or off-peak times. If the cellular network 175 is in an off-peak time, the data exchange may take place immediately via block 630. Otherwise, when the cellular network 175 is in peak times, the data to be exchanged may be cached for later transmission in block 650. Once cached, control returns to decision block 620 so the process may repeat until either a WiFi network 165 becomes available or a cellular network 175 is in an off-peak time. Once either of these conditions is met, the data exchange may be executed in block 630. If, the deadline for consumption of the data exchange occurs before a WiFi network 165 or an off-peak cellular network 175 becomes available, the process may be overridden to use a cellular network 175 in peak times to ensure the data exchange occurs prior to its deadline.

Multi-Path IP Bonding

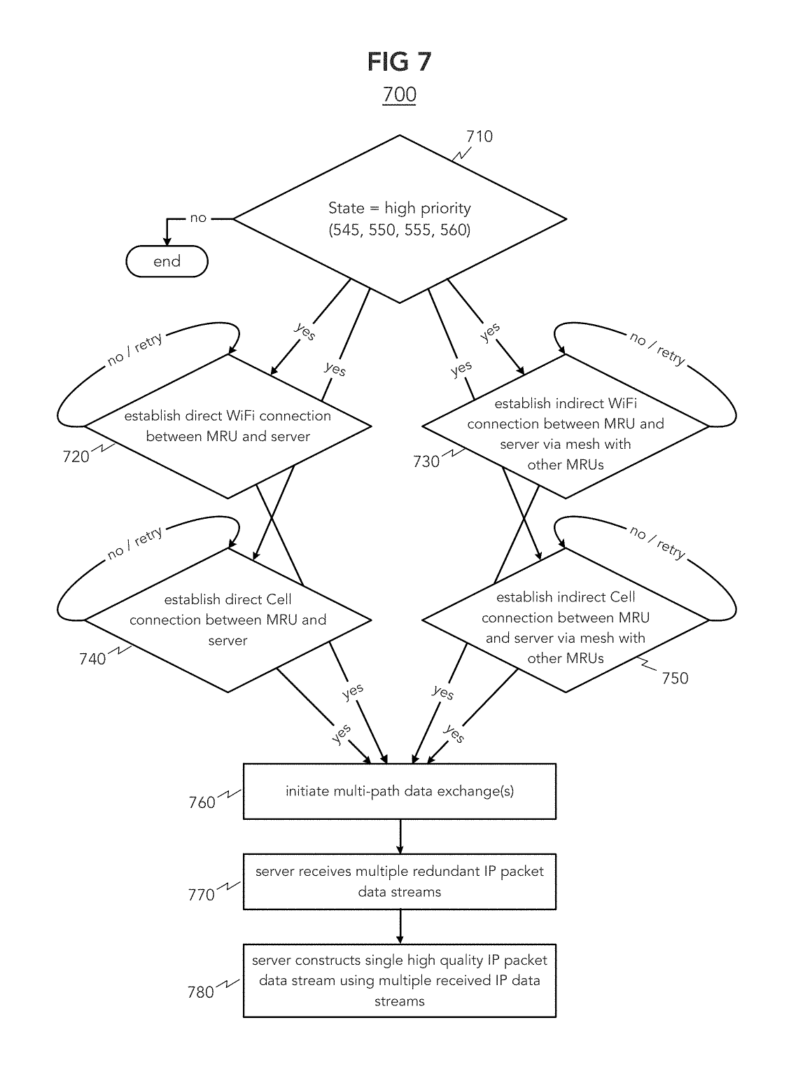

FIG. 7 illustrates still another example of a logic flow diagram 700 according to an embodiment of the invention. Sometimes a data exchange may have a priority high enough to warrant multi-path bonding techniques for exchanging data. These scenarios mean the state of the data exchange from FIG. 5 is high priority. A check may be made in decision block 710 to determine if the state of the data exchange is high priority. For instance, an MRU 100 linked to a video camera may be witnessing a reported crime. The police may wish to retrieve as much information from the video camera (via an MRU 100) as possible as quickly as possible. In such cases, the MRU 100 and the communication server 185 may wish to establish multiple simultaneous communication links to exchange data. The receiving side, which may be either the MRU 100 or the communication server 185, may receive multiple simultaneous IP data streams each identical to the other. There may be processing on the receive side to ensure a single high quality IP data stream by filling in any missing or dropped packets from other streams. The communication server 185 exchanges a single IP data stream with a customer server 190.

If the state of the data exchange is high priority as determined in decision block 710, the sending side, which may be either the MRU 100 or the communication server 185, may initiate four separate determinations regarding communication links between the MRU 100 and the communication server 185. These four decision blocks may include: (i) whether a direct WiFi connection between the MRU 100 and the communication server 185 may be established 720; (ii) whether an indirect WiFi connection between the MRU 100 and the communication server 185 via a mesh network with other MRUs 100 may be established 720; (iii) whether a direct cellular connection between the MRU 100 and the communication server 185 may be established 720; (iv) whether an indirect cellular connection between the MRU 100 and the communication server 185 via a mesh network with other MRUs 100 may be established 750. In each case 720, 730, 740, and 750 if the determination is affirmative meaning a connection may be established between the MRU 100 and the communication server 185, the connection is established and a multi-path data exchange may be initiated in block 760. The data exchange becomes a multi-path data exchange once a second communication link is established between the MRU 100 and the communication server 185. Any time the determination to decision blocks 720, 730, 740, and 750 is negative meaning a connection may not be established between the MRU 100 and the communication server 185, that particular decision block is repeated or re-tried until a connection may be established and the communication link for that connection becomes part of the multi-path data exchange initiated in block 760.

Once a multi-path data exchange is initiated, the communication server 185 (or MRU 100 if it is the receiving entity) receives multiple redundant IP packet data streams in block 770. The communication server 185 or MRU 100 then constructs a single high quality IP packet data stream using the multiple received IP data streams as its source in block 780. For instance, IP data streams may be received over three different communication links. The quality of each IP data stream may vary based on specific network conditions associated with that particular communication link. Some IP data streams may have dropped or missing packets, others may experience a temporary latency. By using the each IP packet data stream as a source, the odds are significantly increased that one (or more) of the IP data streams has successfully received the proper data packet within the prescribed time frame. The communication server 185 or MRU 100 then reconstructs the intended IP packet data stream that should be as close to pristine as possible. This blended reconstructed IP data stream may then be output via its intended mode of consumption.

Network Failover Handling

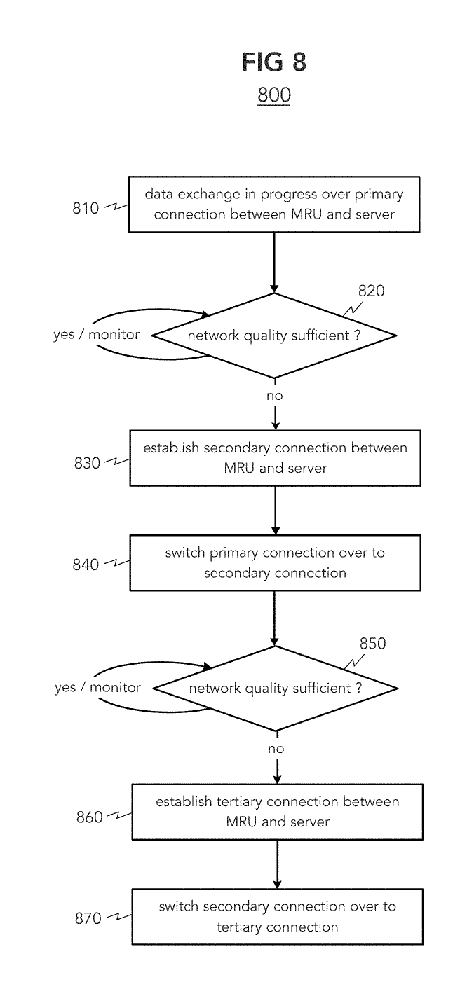

FIG. 8 illustrates still another example of a logic flow diagram 800 according to an embodiment of the invention. Sometimes a data exchange may begin on a first network using a first communication link but that network may become unsatisfactory for a variety of reasons during the data exchange such that a second network and communication link is desired to complete the data exchange. A data exchange between an MRU 100 and a customer server 190 (by way of communication server 185) may be in progress over a first network connection in block 810. Both the MRU 100 and the communication server 185 may monitor one or more network quality parameters including, but not limited to, jitter, delay, noise, latency, detected signal strengths, available networks, protocol and buffer statistics and analysis, environmental and/or geographical factors, the performance of access points and other network components, past interactions between or among communication devices, access points and other network components in decision block 820. Should the totality of the above factors yield satisfactory network conditions, the process will keep monitoring the network for the duration of the data exchange. Should the totality of the above factors yield unsatisfactory network conditions, the MRU 100 or the communication server 185 may initiate a second communication link on a second network in block 830. Upon successful establishment of the second communication link on the second network, the MRU 100 and communication server 185 may now switch from the first communication link to the second communication link meaning the IP data exchange commences on the second communication link over the second network while terminating on the first communication link over the first network in block 840. Just as before, both the MRU 100 and the communication server 185 may monitor the aforementioned network quality parameters in a decision block 850. Should the totality of the above factors yield unsatisfactory network conditions, the MRU 100 or the communication server 185 may initiate a tertiary communication link on yet another network in block 860. Upon successful establishment of the tertiary communication link, the MRU 100 and communication server 185 may now switch from the second communication link to the tertiary communication link meaning the IP data exchange commences on the tertiary communication link while terminating on the second communication link over the second network in block 870. It should be noted that the tertiary communication link and network may be a third communication link and network but may also include the first communication link and network as that network may have solved the problems that led to its unsatisfactory conditions by now.

Mesh Networking

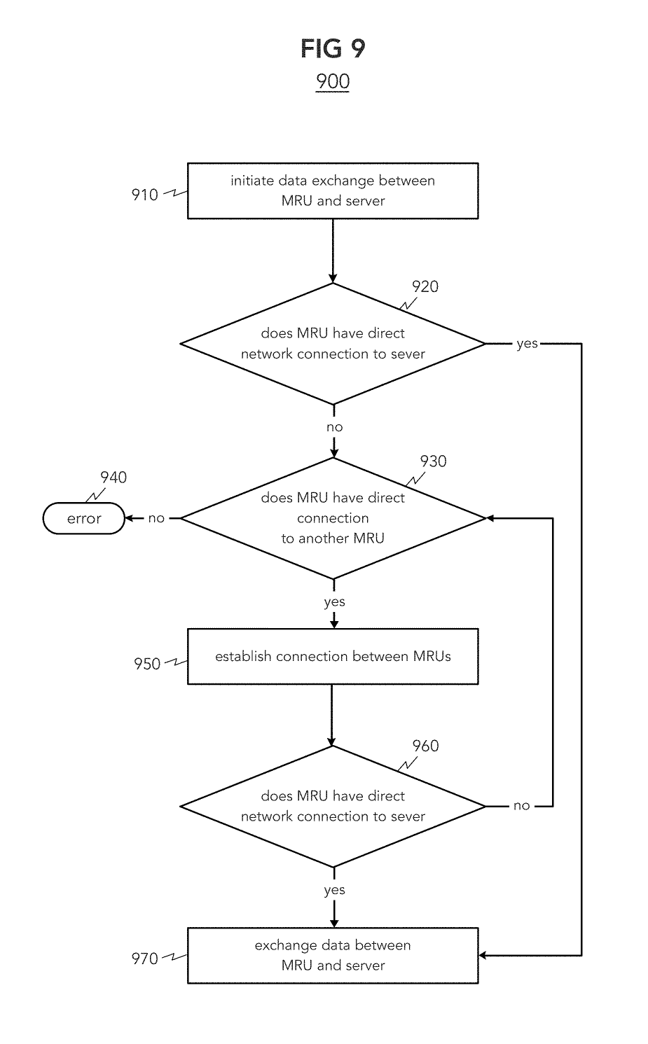

FIG. 9 illustrates still another example of a logic flow diagram 900 according to an embodiment of the invention. Sometimes a data exchange may terminate to or begin from an MRU 100-A that does not have a direct connection with either a cellular basestation 175 or a WiFi access point 170. However, that MRU 100-A may be able to directly communicate to exchange data with another MRU 100-B that may have such a direct connection with either a cellular basestation 175 or a WiFi access point 170. This creates an opportunity for MRU 100-A to still perform data exchanges with communication server 185 indirectly via MRU 100-B. Such an arrangement may be termed a mesh network in which one or more MRUs 100 may communicate directly or sequentially with one another until an MRU 100 is found that has a direct connection with either a cellular basestation 175 or a WiFi access point 170 allowing the data exchange to reach the communication server 185.

In step 910, a data exchange between an MRU 100-A and the communication server 185 may be initiated. The data exchange may be an upload of data from MRU 100-A to communication server 185 or a download of data from communication server 185 to MRU 100-A. It is noted that communication server 185 may be communicable with a customer server 190. In decision block 920, it may be determined whether MRU 100-A does indeed have a direct connection with either a cellular basestation 175 or a WiFi access point 170 allowing the data exchange to reach the communication server 185. If the result is affirmative, such a connection is established and the data exchange occurs as described in block 970. If, however, there is not a direction connection with either a cellular basestation 175 or a WiFi access point 170, control passes to a second decision block 930 to determine whether MRU 100-A has a direct connection to and is communicable with a second MRU 100-B. If the result is negative, an error may be returned in block 940 and the data exchange between MRU 100-A and communication server 185 may not occur. If the result is affirmative, a direct connection between MRU 100-A and MRU 100-B is established in block 950. Control passes to another decision block 960 to determine (as was done in decision block 920) whether MRU 100-B has a direct connection with either a cellular basestation 175 or a WiFi access point 170. If so, such a connection is established and the data exchange occurs as described in block 970 in which MRU 100-B is in the path between communication server 185 and MRU 100-A. If there is no such connection between MRU 100-B and either a cellular basestation 175 or a WiFi access point 170, control is passed back to decision block 930 to determine whether MRU 100-B has a direct connection to and is communicable with a third MRU 100-C. This process repeats itself to try to find an MRU 100 that does have a direct connection with either a cellular basestation 175 or a WiFi access point 170. If none is found, the data exchange does not occur. If one is found, the data exchange may occur between communication server 185 and MRU 100-A via a mesh network that includes any other MRUs 100 needed to bridge the connection between communication server 185 and MRU 100-A.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus comprising:
one or more processors;
one or more data storage components;
a plurality of RF transceivers;
a plurality of antennas operatively coupled to the plurality of RF transceivers; and
logic, at least a portion of which is implemented in circuitry, the logic to implement:
a mesh module configured to communicate with other apparatuses directly using a dedicated one of the plurality of RF transceivers;
a caching module configured to store data to be exchanged with a communication server at a later date; and
a bonding module configured to: (i) receive multiple identical IP data streams via the plurality of RF transceivers; and (ii) send multiple identical IP data streams via the plurality of RF transceivers to the same destination.

2. The apparatus of claim 1 further comprising:
a plurality of subscriber identity module (SIM) card slots configured to accept a plurality of SIM cards, each SIM card operable with a different mobile network.

3. The apparatus of claim 2 wherein the at least one of the plurality of transceivers is a cellular transceiver.

4. The apparatus of claim 2 wherein the at least one of the plurality of transceivers is an 802.11 WiFi based transceiver.

5. The apparatus of claim 2 wherein the at least one of the plurality of transceivers is a Bluetooth transceiver.

6. The apparatus of claim 2 wherein the at least two of the plurality of transceivers are 802.11 WiFi based transceivers, wherein one of the two WiFi based transceivers is dedicated to mesh communications with other dedicated WiFi based transceivers in other apparatuses.

7. The apparatus of claim 1 further comprising:
a video interface module coupled with the one or more processors, the video interface module configured to receive and relay video data information;

8. The apparatus of claim 7 further comprising a display, the display configurable to receive and render the video data information from the video interface module.

9. The apparatus of claim 1 further comprising:
an audio interface module coupled with the one or more processors, the audio interface module configured to receive and relay audio data information;

10. The apparatus of claim 9 further comprising a speaker, the speaker configurable to receive and render the audio data information from the audio interface module.

11. The apparatus of claim 1 further comprising memory card slots coupled with the one or more processors, the memory card slots configured to receive external memory cards and exchange data via the one or more processors.

12. The apparatus of claim 1 further comprising universal serial bus (USB) ports coupled with the one or more processors, the USB ports configured to receive a USB cable and exchange data via the one or more processors.
